(19) United States
(12) Patent Application Publication
(10) Pub. No.: US 2024/0401265 A1
(43) Pub. Date: Dec. 5, 2024

(54) THERMOPLASTIC UNIDIRECTIONAL TAPE WITH DISCONTINUOUS COATING LAYER

(71) Applicant: Toray Advanced Composites USA Inc., Morgan Hill, CA (US)

(72) Inventors: Daisuke Komori, San Jose, CA (US); Naoki Matsuura, San Jose, CA (US); Lawrence Pranger, San Jose, CA (US); Arthur Schlothauer, Palo Alto, CA (US)

(73) Assignee: Toray Advanced Composites USA Inc., Morgan Hill, CA (US)

(21) Appl. No.: 18/680,510

(22) Filed: May 31, 2024

Related U.S. Application Data
(60) Provisional application No. 63/469,997, filed on May 31, 2023.

(51) Int. Cl. D06N 3/12; D04H 1/4242; D04H 1/74; D06N 3/00

(52) U.S. Cl. CPC D06N 3/12; D04H 1/4242; D04H 1/74; D06N 3/0011; D06N 3/0015; D06N 3/0063; D06N 3/0077; D06N 2205/10; D06N 2209/041

(57) ABSTRACT

Described herein are unidirectional tapes and methods of making thereof. The unidirectional tapes disclosed herein include a unidirectional fiber layer and discontinuous coating layer that includes a plurality of discontinuous coating regions on at least one side of the unidirectional fiber layer.

### REFERENCE TO RELATED APPLICATIONS

This application claims the benefit of priority to U.S. Provisional Application No. 63/469,997, filed May 31, 2023, the entire contents of which are incorporated herein by reference.

### FIELD OF THE DISCLOSURE

This disclosure relates to unidirectional tapes and methods for making these unidirectional tapes. More particularly, to unidirectional tapes having a discontinuous coating layer on at least one surface of a unidirectional fiber layer and methods of making thereof.

### BACKGROUND OF THE DISCLOSURE

Unidirectional tapes (UD tapes) are composite materials with unidirectionally aligned reinforcing fibers that are typically impregnated with a polymer resin. When compared to conventional materials (e.g., aluminum and steel and their various alloys), UD tapes have various structural advantages such as high stiffness and strength with low weight. Thus, UD tapes are used in a wide range of applications including in the aerospace, automotive, and consumer electronic industries.

Subsequent processing of these UD tapes can include tacking, tape placement, tape laying, consolidation, or welding, among others. Specifically, the UD tapes are often heated such that the polymers of the tape can melt and/or soften so that adjacent layers of tape may bind or laminate together. The ease or difficulty of the subsequent processing of the UD tapes can depend on the various properties of such UD tapes.

### SUMMARY OF THE DISCLOSURE

Disclosed herein are unidirectional tapes and methods of making thereof with improved processing and formability. Using unidirectional tapes typically encompass melting the polymer resin in the UD tapes to build a coherent stack or laminate of multiple plies by, for example, stamp forming, thermoforming, and other lamination techniques (e.g., automated fiber placement (AFP), automated tape layup (ATL), etc.). The UD tapes disclosed herein can improve the processing and formability in such processes.

Specifically, the unidirectional tapes disclosed herein can include a discontinuous coating layer on at least one surface of a unidirectional fiber layer substrate. The discontinuous coating layer can include a plurality of discontinuous coating regions on the at least one surface of the unidirectional fiber layer substrate. In some embodiments, the discontinuous coating layer can reduce the friction between adjacent plies (ply-ply friction), increase or maintain degassing efficiency by preserving inter-ply channels, increase or maintain inter-ply thermal and electrically conductivity (e.g., Z-conductivity), and/or increase tackiness during layup.

In some embodiments, a unidirectional tape includes a unidirectional fiber layer comprising a plurality of unidirectional fibers and a first polymer; and a discontinuous coating layer comprises a plurality of discontinuous coating regions on at least one side of the unidirectional fiber layer, wherein the discontinuous coating layer comprises a second polymer. In some embodiments, the discontinuous coating layer covers 5-75% of a surface area of the at least one side of the unidirectional fiber layer. In some embodiments, a thickness of the unidirectional tape has a coefficient of variation (CoV) of 5-50%. In some embodiments, the first polymer and/or second polymer comprises polyarylether ketone (PAEK), polyphenylene sulfide (PPS), polyethersulfone (PES or PESU), polyethylenimine (PEI), or combinations thereof. In some embodiments, the first and second polymers are the same. In some embodiments, the plurality of unidirectional fibers comprises carbon fibers, glass fibers, or combinations thereof. In some embodiments, the discontinuous coating layer comprises additives such as conductive additives. In some embodiments, the conductive additives comprise carbon particles. In some embodiments, the carbon particles have a mean diameter of a volume distribution of 10-50 microns. In some embodiments, the discontinuous coating layer comprises 2-10 wt. % carbon particles. In some embodiments, the unidirectional fiber layer comprises additives such as conductive additives. In some embodiments, the conductive additives comprise carbon black, graphene, carbon nanotubes (CNT), milled carbon fiber, milled carbon fiber prepreg, or combinations thereof. In some embodiments, the conductive additives have a mean diameter of a volume distribution of 20 nanometers to 1 micron. In some embodiments, the unidirectional fiber layer comprises 0.1-10 wt. % conductive additives. In some embodiments, the unidirectional tape has a tackiness as measured by average or max weld strength of at least about 500 lb/in. In some embodiments, the unidirectional tape has a ply-ply slip that leads to a wrinkle free laminate surface. In some embodiments, the unidirectional tape disclosed herein has a ply-ply slip that leads to a reduction in ply-ply friction by up to 70% compared to tape with no coating. In some embodiments, the unidirectional tape disclosed herein can have a max void content of about 0.01-6%.

In some embodiments, a method of producing a unidirectional tape includes preparing a unidirectional fiber layer comprising a plurality of unidirectional fibers and a first polymer; discontinuously coating at least one side of the unidirectional fiber layer with a plurality of particles comprising a second polymer; heating the plurality of particles such that the plurality of particles coalesce into a plurality of discontinuous regions on the at least one side of the unidirectional fiber layer; and pressing the at least one side of the coated unidirectional fiber layer to form the unidirectional tape. In some embodiments, the plurality of particles have an average particle diameter of about 5-500 microns. In some embodiments, the method includes pressing the at least one side of the coated unidirectional fiber layer at a pressure of 0.1-10 N/mm. In some embodiments, discontinuously coating the at least one side of the unidirectional fiber with a plurality of particles comprises electrostatically depositing the plurality of particles.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

It is understood that aspects and embodiments described herein include “consisting” and/or “consisting essentially of” aspects and embodiments. For all methods, systems, compositions, tapes, and devices described herein, the methods, systems, compositions, tapes, and devices can either comprise the listed components or steps, or can “consist of” or “consist essentially of” the listed components or steps. When a system, composition, tape, or device is described as “consisting essentially of” the listed components, the system, composition, tape, or device contains the components listed, and may contain other components which do not substantially affect the performance of the system, composition, tape, or device, but either do not contain any other components which substantially affect the performance of the system, composition, tape, or device other than those components expressly listed; or do not contain a sufficient concentration or amount of the extra components to substantially affect the performance of the system, composition, tape, or device. When a method is described as “consisting essentially of” the listed steps, the method contains the steps listed, and may contain other steps that do not substantially affect the outcome of the method, but the method does not contain any other steps which substantially affect the outcome of the method other than those steps expressly listed.

In the disclosure, “substantially free of” a specific component, a specific composition, a specific compound, or a specific ingredient in various embodiments, is meant that less than about 5%, less than about 2%, less than about 1%, less than about 0.5%, less than about 0.1%, less than about 0.05%, less than about 0.025%, or less than about 0.01% of the specific component, the specific composition, the specific compound, or the specific ingredient is present by weight. Preferably, “substantially free of” a specific component, a specific composition, a specific compound, or a specific ingredient indicates that less than about 1% of the specific component, the specific composition, the specific compound, or the specific ingredient is present by weight.

Additional advantages will be readily apparent to those skilled in the art from the following detailed description. The examples and descriptions herein are to be regarded as illustrative in nature and not restrictive.

### BRIEF DESCRIPTION OF THE FIGURES

Various embodiments are described, by way of example only, with reference to the accompanying drawings, in which:

FIG. 1A illustrates an example of a cross sectional view of a unidirectional tape in accordance with some embodiments disclosed herein.

FIG. 1B illustrates an example of a cross sectional view of a unidirectional tape with a continuous coating layer in accordance with some embodiments disclosed herein.

FIG. 2 illustrates an example of a cross sectional view of a unidirectional tape with additives in accordance with some embodiments disclosed herein.

FIG. 3A illustrates an example of a top view at 200× magnification of a UD tape without a coating layer in accordance with some embodiments disclosed herein.

FIG. 3B illustrates a cross-sectional view at 500× magnification of a UD tape without a coating layer in accordance with some embodiments disclosed herein.

FIG. 4A illustrates an example of a top view at 200× magnification of a UD tape with a light coating layer in accordance with some embodiments disclosed herein.

FIG. 4B illustrates a cross-sectional view at 500× magnification of a UD tape with a light coating layer in accordance with some embodiments disclosed herein.

FIG. 5A illustrates an example of a top view at 200× magnification of a UD tape with a medium coating layer in accordance with some embodiments disclosed herein.

FIG. 5B illustrates a cross-sectional view at 500× magnification of a UD tape with a medium coating layer in accordance with some embodiments disclosed herein.

FIG. 6A illustrates an example of a top view at 200× magnification of a UD tape with a heavy coating layer in accordance with some embodiments disclosed herein.

FIG. 6B illustrates a cross-sectional view at 500× magnification of a UD tape with a heavy coating layer in accordance with some embodiments disclosed herein.

FIG. 7A illustrates a magnified and smaller segment of a 15 mm wide image of a UD tape for calculating roughness (CoV) in accordance with some embodiments disclosed herein.

FIG. 7B illustrates an example of black and white thresholding of FIG. 7A in accordance with some embodiments disclosed herein.

In the Figures, like references refer to like components unless stated differently herein.

### DETAILED DESCRIPTION OF EXEMPLARY EMBODIMENTS

Described herein are unidirectional tapes and methods of producing unidirectional tapes with improved processing and formability in processes such as stamp forming, thermoforming, and other advanced lamination techniques (e.g., automated tape layup (ATL) and automated fiber placement (AFP)), among others. To achieve the improved processing and formability, the surface or surfaces of the unidirectional fiber layer substrate of the UD tape can be modified by applying a partial coating on the surface(s). This partial coating is a discontinuous coating having a plurality of discontinuous coating regions on the unidirectional fiber layer substrate, rather than a continuous coating on the unidirectional fiber layer substrate or no coating on the unidirectional fiber layer.

Specifically, Applicant has discovered that the specific amounts of surface area coverage and/or surface roughness disclosed herein for the discontinuous coating layer(s) of the UD tapes can: (1) provide a balance between increased tackiness (for good stack registration) and reduced ply-ply slip/friction or ply-mold slip/friction (for improved part forming); (2) preserve or maintain pathways for degassing in the form of inter-ply channels between a first ply and mold and/or between two plies, while (3) preserving a low void content and (4) good electrical and/or thermal conductivity in the ensuing laminate.

In order to produce the unidirectional tape, a unidirectional fiber layer can be prepared. In some embodiments, the unidirectional fiber layer can be a base layer, a substrate layer and/or core layer for the discontinuous coating layers disclosed herein. In some embodiments, the unidirectional fiber layer can include a layer of fibers (e.g., reinforcing fibers). In some embodiments, the unidirectional fiber layer can include a plurality of unidirectional fibers. In some embodiments, the unidirectional fibers of the fiber layer (and unidirectional fiber layer) can be arranged to lie in a unidirectional orientation. In some embodiments, at least about 75%, at least about 80%, at least about 85%, at least about 90%, at least about 95%, or at least 98% of the fibers of the unidirectional fiber layer can lie in a unidirectional orientation. There may be no specific limitations or restrictions on the type or types of fibers used in the unidirectional tapes disclosed herein. In some embodiments, the fibers can include glass fiber, carbon fiber, graphite fiber, aramid fiber, boron fiber, alumina fiber, silicon carbide fiber, or combinations thereof.

In some embodiments, the unidirectional fiber layer can include at least one polymer. In some embodiments, the plurality of unidirectional fibers can be embedded and/or dispersed in the at least one polymer. In some embodiments, the at least one polymer can be a polymer resin such as a neat polymer resin or a polymer resin compounded with additives disclosed herein. In some embodiments, the at least one polymer can be a plurality of polymer particles.

In some embodiments, the at least one polymer can include a thermoplastic polymer. In some embodiments, the at least one polymer can be polyamides, polycarbonates, polyacetals, polyphenylene oxides, polyphenylene sulfides, polyarylates, polyesters, polyamideimides, polyimides, polyetherimides, polyimides with a phenyltrimethylindane structure, polysulfones, polyethersulfoies, polyetherketones, polyetheretherketones, polyaramids, polyethernitriles, polybenzimidazoles, or combinations thereof. In some embodiments, the at least one polymer can include polyarylether ketone (PAEK), polyphenylene sulfide (PPS), polyethersulfone (PES or PESU), polyethylenimine (PEI), polysulfone (PSU), or combinations thereof. In some embodiments, the at least one polymer can include poly-ether-ketone (PEK), polyether-ether-ketone (PEEK), poly-ether-ether-ketone-ketone (PEEKK), poly-ether-ether-ketone-ketone (PEKK), poly-ether-ketone-ether-ketone-ketone (PEKEKK), poly-ether-ether-ketone-ether-ketone (PEEKEK), poly-ether-ether-ether-ketone (PEEEK), and poly-ether-diphenyl-ether-ketone (PEDEK), polyaryletherketone (PAEK)-based polymeric material with reactive (end) groups, or combinations thereof. In some embodiments, the PAEK-based polymers can include a range of variants commonly called Low-Melt Polyaryletherketone (LMPAEK™), which can have lower melting temperature for faster processing but comparable mechanical properties compared to other PAEK-based polymers such as PEEK and PEKK.

In some embodiments, the unidirectional fiber layer can include additives. As stated above, in some embodiments, the at least one polymer can be compounded with additives. In some embodiments, the additives can enhance performance of the consolidated laminate, for example. In some embodiments, the additives can be electrically conductive, dielectric, non-conductive, and/or a combination of other types of additives. In some embodiments, the additives can impart properties other than or in combination with conductivity. In some embodiments, additives can be added to impart insulating properties, thermal properties, chemical properties, and/or mechanical properties. For example, additives can be added to impart strength, toughness, thermal stability, CTE, and/or resistance to environmental degradation, among others. In some embodiments, the additives can be electrically conductive additives for enhanced electrical conductivity of the unidirectional fiber layer. For example, the conductive additives can include carbon particles, carbon black, graphene, carbon nanotubes (CNT), milled carbon fiber, milled carbon fiber prepreg, or combinations thereof. In some embodiments, the additives can have a characteristic length or diameter of about 20 nm to 1 micron. In some embodiments, the characteristic length can be the largest dimension of the additive. In some embodiments, the additives can be mixed and/or melt mixed with the at least one polymer before impregnation.

In some embodiments, the additives (and at least one polymer) can be well dispersed in the unidirectional fiber layer. In some embodiments, the amount (or concentration) of the additives can depend on how well dispersed the additives are in the unidirectional fiber layer. For example, the amount (or concentration) for percolation can depend on how well dispersed the additives in the unidirectional fiber layer are. As the degree of additive dispersion increases, the concentration/amount of additive to achieve the percolation threshold concentration for electrical conductivity can decrease. In some embodiments, the unidirectional fiber layer can include at least about 0.001 wt. %, at least about 0.1 wt. %, at least about 0.5 wt. %, at least about 1 wt. %, at least about 2 wt. %, at least about 5 wt. %, at least about 7 wt. %, or at least about 9 wt. % additives (e.g., conductive additives and/or other additives). In some embodiments, the unidirectional fiber layer can include at most about 15 wt. %, at most about 12 wt. %, at most about 10 wt. %, at most about 8 wt. %, at most about 6 wt. %, at most about 5 wt. %, at most about 3 wt. %, or at most about 1 wt. % additives (e.g., conductive additives and/or other additives). In some embodiments, the unidirectional fiber layer can include about 0.1-10 wt. % additives (e.g., conductive additives and/or other additives).

In some embodiments, the unidirectional fiber layer can be prepared by impregnating the plurality of unidirectional fibers (i.e., the fiber layer(s)) with the at least one polymer (and additives). Impregnation of the fiber layer can be carried out using any technique known by those of skill in the art including a wet method and a hot melt method (i.e., dry method). In some embodiments, the hot melt method can include the use of an extruder to melt the polymer and impregnate the fiber layer (e.g., reinforcing fibers). In some embodiments, impregnation of the fiber layer can take place in an impregnation bath (e.g., a container or vessel with the impregnation slurry/solution). In some embodiments, the fiber layer can be impregnated with the impregnation slurry/solution by moving or pulling the fiber layer through the impregnation bath. In some embodiments, impregnating the fiber layer with the at least one polymer can form the unidirectional fiber layer. In some embodiments, the wet method can include immersing the fiber layer (e.g., reinforcing fibers) in an impregnation slurry or solution that includes at least one polymer. In some embodiments, the impregnation slurry or solution may comprise at least one primary particle and at least one secondary particle as described in PCT Publication No. WO2022043391A1, which is hereby incorporated by reference in its entirety.

In some embodiments, the at least one polymer can be mixed and/or dissolved in the slurry/solution in at least one solvent such as water, methyl ethyl ketone, and/or an alcohol (e.g., methanol, etc.) and then the fiber layer immersed in the slurry/solution. After immersion, the solvent can be removed via evaporation (in an oven for example) to obtain the unidirectional fiber layer. In some embodiments, the hot melt method can include applying the at least one polymer (and additives) by using an extruder to melt the polymer, and then coating the fiber layer with the at least one polymer and then heating and applying pressure to the at least one polymer layer/coating and the fiber layer such that the at least one polymer impregnates the fiber layer.

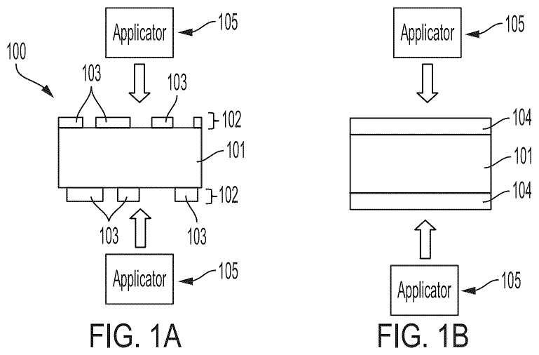

After a unidirectional fiber layer is prepared or provided, a discontinuous coating layer can be applied to at least one side/surface of the unidirectional fiber layer. In some embodiments, the unidirectional fiber layer (one or both sides/surfaces of the layer) can be discontinuously coated with at least one polymer. In some embodiments, the at least one polymer can be a plurality of particles. In some embodiments, a discontinuous coating layer is applied to both sides of the unidirectional fiber layer. The discontinuous coating layer can be a plurality of discontinuous coating regions on a surface of the unidirectional fiber layer. For example, the plurality of discontinuous coating regions can be spaced apart, discrete regions of coating material (e.g., polymers and/or additives) on a surface of the unidirectional fiber layer. The plurality of discontinuous coating regions can be disposed on the unidirectional fiber layer such that they are non-contiguous with any other coating region of the plurality of coating regions. In other words, discontinuous coating layer can have a “sea-island” morphology, wherein the discrete coating regions of the coating layer are the islands protruding above a surface (i.e., sea) of the unidirectional fiber layer. FIG. 1A illustrates a cross sectional view of an example unidirectional tape 100 with unidirectional fiber layer 101 and discontinuous coating layer 102 with discontinuous coating regions 103 on both sides of the unidirectional fiber layer. In contrast to the unidirectional tapes disclosed herein, FIG. 1B illustrates an example of a continuous coating layer 104 on both surfaces of the unidirectional fiber layer 101.

In some embodiments, the at least one polymer of the discontinuous coating layer can be any polymer disclosed herein including those used to prepare the unidirectional fiber layer. In other words, the at least one polymer of the discontinuous coating layer can be a polymer resin such as a neat polymer resin or a polymer resin compounded with additives disclosed herein. In some embodiments, the at least one polymer of the discontinuous coating layer can be a plurality of polymer particles.

In some embodiments, the at least one polymer in the discontinuous coating can be a thermoplastic polymer. In some embodiments, the at least one polymer can be polyamides, polycarbonates, polyacetals, polyphenylene oxides, polyphenylene sulfides, polyarylates, polyamideimides, polyimides, polyetherimides, polyimides with a phenyltrimethylindane structure, polysulfones, polyethersulfones, polyetherketones, polyetheretherketones, polyaramids, polyethernitriles, polybenzimidazoles, or combinations thereof. In some embodiments, the at least one polymer can be polyamides, polycarbonates, polyacetals, polyphenylene oxides, polyphenylene sulfides, polyarylates, polyesters, polyamideimides, polyimides, polyetherimides, polyimides with a phenyltrimethylindane structure, polysulfones, polyethersulfones, polyetherketones, polyetheretherketones, polyaramids, polyethernitriles, polybenzimidazoles, or combinations thereof. In some embodiments, the at least one polymer can include polyarylether ketone (PAEK), polyphenylene sulfide (PPS), polyethersulfone (PES or PESU), polyethylenimine (PEI), polysulfone (PSU), or combinations thereof. In some embodiments, the at least one polymer can include poly-ether-ketone (PEK), polyether-ether-ketone (PEEK), poly-ether-ether-ketone-ketone (PEEKK), poly-ether-ether-ketone-ketone (PEKK), poly-ether-ketone-ether-ketone-ketone (PEKEKK), poly-ether-ether-ketone-ether-ketone (PEEKEK), poly-ether-ether-ether-ketone (PEEEK), and poly-ether-diphenyl-ether-ketone (PEDEK), polyaryletherketone (PAEK)-based polymeric material with reactive (end) groups, or combinations thereof. In some embodiments, the PAEK-based polymers can include a range of variants commonly called Low-Melt Polyaryletherketone (LMPAEK™), which can have lower melting temperature for faster processing but comparable mechanical properties compared to other PAEK-based polymers such as PEEK and PEKK.

As such, in some embodiments, the unidirectional fiber layer can include a first polymer and the discontinuous coating layer can include the same polymer or different polymer(s). In some embodiments, the polymer (or polymer resin) that impregnates the fiber layer can be the same polymer (or polymer resin) utilized to form the discontinuous coating layer on the unidirectional fiber layer substrate.

In some embodiments, the plurality of (polymer) particles can be applied to a surface of the unidirectional fiber layer as a dry powder or liquid. In some embodiments, discontinuously coating at least one side/surface of the unidirectional fiber layer with a plurality of (polymer) particles can include melt sputter coating, plasma spraying, and/or electrostatically depositing the plurality of particles on the at least one side/surface of the unidirectional fiber layer. In some embodiments, deposition can be performed by applicator 105, as shown in FIGS. 1A-B.

In some embodiments, the plurality of (polymer) particles used for the discontinuous coating layer can have a mean diameter of the volume distribution of at least about 5 microns, at least about 10 microns, at least about 20 microns, at least about 40 microns, at least about 60 microns, at least about 65 microns, at least about 70 microns, at least about 75 microns, at least about 100 microns, at least about 125 microns, at least about 135 microns, at least about 150 microns, at least about 175 microns, or at least about 200 microns. In some embodiments, the plurality of (polymer) particles used for the discontinuous coating layer can have a mean diameter of the volume distribution of at most about 500 microns, at most about 475 microns, at most about 450 microns, at most about 425 microns, at most about 400 microns, at most about 350 microns, at most about 325 microns, at most about 300 microns, at most about 250 microns, at most about 225 microns, at most about 200 microns, at most about 175 microns, at most about 150 microns, or at most about 125 microns. In some embodiments, the plurality of (polymer) particles used for the discontinuous coating layer can have a mean diameter of the volume distribution of about 5-500 microns, about 20-500 microns, about 35-400 microns, about 50-300 microns. In some embodiments, if the plurality of (polymer) particles used for the discontinuous coating layer have a mean diameter of the volume distribution too small a gritty coating discontinuous coating surface may not be achieved and/or the flow of particles may be uneven. In some embodiments, the mean diameter of a volume distribution can be measured by convention laser diffraction particle size analyzers, where the average particle size is reported as a mean volume or a D50 value.

In some embodiments, the discontinuous coating layer can include additives. As explained above, the at least one polymer of the discontinuous coating layer can be a neat resin, or the at least one polymer of the discontinuous coating layer can be compounded with additives. In some embodiments, the at least one polymer resin (which can include additives) of the discontinuous layer can be the same or different composition as the at least one polymer resin used to form the unidirectional fiber layer. In some embodiments, the additives of the discontinuous coating layer can enhance performance of the consolidated laminate formed using the unidirectional tape disclosed herein, for example. In some embodiments, the additives can be electrically conductive, dielectric, non-conductive, and/or a combination of other types of additives. In some embodiments, the additives can impart properties other than or in combination with conductivity. In some embodiments, additives can be added to impart insulating properties, thermal properties, chemical properties, and/or mechanical properties. For example, additives can be added to impart strength, toughness, thermal stability, CTE, and/or resistance to environmental degradation, among others. In some embodiments, the additives can be electrically conductive additives for enhanced electrical conductivity of the unidirectional tape. For example, the conductive additives can include carbon particles, carbon black graphene, carbon nanotubes (CNT), milled carbon fiber, milled carbon fiber prepreg, or combinations thereof.

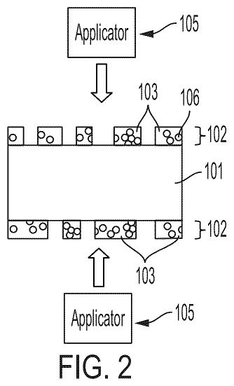

FIG. 2 illustrates a cross sectional view of an example unidirectional tape 100 with unidirectional fiber layer 101 and discontinuous coating layer 102 with discontinuous coating regions 103 that include additives 106 dispersed within the polymer(s) of the discontinuous coating regions. In some embodiments, the additives can have a mean diameter of the volume distribution of at least about 5 microns, at least about 10 microns, at least about 15 microns, at least about 20 microns, at least about 25 microns, at least about 30 microns, or at least about 35 microns. In some embodiments, the additives can have a mean diameter of the volume distribution of at most about 100 microns, at most about 75 microns, at most about 60 microns, at most about 65 microns, at most about 50 microns, at most about 45 microns, at most about 40 microns, at most about 35 microns, at most about 30 microns, or at most about 25 microns. In some embodiments, the additives can have a mean diameter of the volume distribution of about 5-100 microns, about 10-50 microns, or about 20-40 microns. In some embodiments, if the mean diameter of the volume distribution of the additives is less than 5 microns or greater than 100 microns, the overall UD tape may have poor conductivity and/or ply-ply slip.

In some embodiments, the additives can be mixed or blended with the plurality of (at least one polymer) particles before coating on a surface of the unidirectional fiber layer. In some embodiments, the conductive additive is carbon particles. In some embodiments, the carbon particles can be spherical-shaped carbon particles.

In some embodiments, the additives can be well dispersed in the discontinuous coating layer. In some embodiments, the additives can be well dispersed in the polymer of the discontinuous coating layer. In some embodiments, the amount (or concentration) of the additives can depend on how well dispersed the additives are in the discontinuous coating layer. In some embodiments, the discontinuous coating layer can include at least about 1 wt. %, at least about 2 wt. %, at least about 5 wt. %, at least about 8 wt. %, at least about 10 wt. %, at least about 12 wt. %, at least about 15 wt. %, or at least about 18 wt. % additives (e.g., conductive, dielectric, and/or other additives). In some embodiments, the discontinuous coating layer can include at most about 25 wt. %, at most about 20 wt. %, at most about 18 wt. %, at most about 15 wt. %, at most about 12 wt. %, at most about 10 wt. %, at most about 8 wt. %, or at most about 5 wt. % additives (e.g., conductive, dielectric, and/or other additives). In some embodiments, the discontinuous coating layer can include less than about 20 wt. % or about 2-10 wt. % additives (e.g., conductive, dielectric, and/or other additives). In some embodiments, if the amount of additives in the discontinuous coating layer is less than 2 wt %, the overall UD tape may have poor conductivity and/or ply-ply slip.

In some embodiments, after the plurality of (polymer) particles (with or without additives) have been discontinuously coated on at least one surface/side of a unidirectional fiber layer, the plurality of particles can be heated such that they coalesce into a plurality of discontinuous regions on the at least one surface/side of the unidirectional fiber layer. In other words, the plurality of (polymer) particles that have been discontinuously coated on a surface of the unidirectional fiber layer can be heated above their melting temperature such that they coalesce into a plurality of discontinuous regions on the at least one surface/side of the unidirectional fiber layer. In some embodiments, the plurality of discontinuous regions can form the plurality of discontinuous coating regions on a surface of the unidirectional fiber layer. In some embodiments, these plurality of discontinuous regions can be spaced apart, discrete regions of coating material on a surface of the unidirectional fiber layer. The plurality of discontinuous regions can be disposed on the unidirectional fiber layer such that they are non-contiguous with any other region of the plurality of discontinuous regions.

In some embodiments, the plurality of (polymer) particles can coalesce into discrete coating regions (i.e., islands) on a surface of the unidirectional fiber layer (i.e., sea) to form a “sea-island” morphology. In some embodiments, the plurality of discontinuous regions on the at least one surface/side of the unidirectional fiber layer can be cooled after heating. In some embodiments, the coated unidirectional fiber layer can be cooled. In some embodiments, the entire unidirectional tape can be cooled.

In some embodiments, the average surface area (i.e., size) of the plurality of discontinuous coating regions (average discontinuous coating region surface area) on the at least one side of the unidirectional fiber layer can be at least about 500 microns², at least about 1000 microns², at least about 2000 microns², at least about 2500 microns², at least about 3000 microns², at least about 3500 microns², at least about 4000 microns², at least about 5000 microns², or at least about 7500 microns². In some embodiments, the average surface area of the plurality of discontinuous coating regions on the at least one side of the unidirectional fiber layer can be at most about 300,000 microns², at most about 200,000 microns², at most about 100,000 microns², at most about 50,000 microns², at most 20,000 microns², at most about 15000 microns², at most about 10000 microns², at most about 8000 microns², at most about 7500 microns², at most about 6000 microns², at most about 5000 microns², at most about 4500 microns², at most about 4000 microns², at most about 3500 microns², at most about 3000 microns², at most about 2500 microns², or at most about 2000 microns².

In some embodiments, at most about 99%, at most about 90%, at most about 85%, at most about 75%, at most about 70%, at most about 65%, at most about 60%, at most about 55%, or at most about 50% of the plurality of discontinuous coating regions on the at least one side of the unidirectional fiber layer can have a surface area of at least about 200 microns² or at least about 500 microns². In some embodiments, at least about 45%, at least about 50%, at least about 55%, or at least about 60% of the plurality of discontinuous coating regions on the at least one side of the unidirectional fiber layer can have a surface area of at least about 200 microns² or at least about 500 microns².

In some embodiments, the at least one side of the coated unidirectional fiber layer can be pressed to form the unidirectional tape. In some embodiments, both sides of the coated unidirectional fiber layer can be pressed to form the unidirectional tape. In other words, the coated unidirectional fiber layer can be compacted to form the unidirectional tape. In some embodiments, the coated unidirectional fiber layer can be cooled under compaction. In some embodiments, the pressing (or compaction) can be via a compaction roller. In some embodiments, pressing/compacting the at least one side of the coated unidirectional fiber layer can be at a pressure of about 0.1-10 N/mm, about 0.1-2 N/mm, about 2-5 N/mm, or about 5-10 N/mm. In some embodiments, pressing/compacting the at least one side of the coated unidirectional fiber layer can be at a pressure of at least about 0.1 N/mm, at least about 0.5 N/mm, at least about 1 N/mm, at least about 1.5 N/mm, at least about 2 N/mm, at least about 3 N/mm, at least about 4 N/mm, at least about 5 N/mm, at least about 6 N/mm, at least about 7 N/mm, at least about 8 N/mm, or at least about 9 N/mm. In some embodiments, pressing/compacting the at least one side of the coated unidirectional fiber layer can be at a pressure of at most about 10 N/mm, at most about 5 N/mm, at most about 4 N/mm, at most about 3 N/mm, at most about 2 N/mm, at most about 1.5 N/mm, or at most about 1 N/mm. In some embodiments, the pressing/compacting pressure can be calculated as total compaction force on the tape divided by the tape width.

In some embodiments, a discontinuous coating layer covers at least a portion of the surface area of the at least one side/surface of the unidirectional fiber layer. In other words, at least a portion of the surface area of the unidirectional fiber layer is covered by a plurality of discontinuous coating regions. In some embodiments, a discontinuous coating layer covers at least about 5%, at least about 10%, at least about 15%, at least about 20%, at least about 25%, at least about 27%, at least about 30%, at least about 35%, at least about 40%, at least about 45%, at least about 50%, at least about 55%, at least about 60%, at least about 65%, or at least about 70% of the surface area of the at least one side/surface of the unidirectional fiber layer. In some embodiments, a discontinuous coating layer covers at most about 85%, at most about 80%, at most about 75%, at most about 65%, at most about 55%, at most about 50%, at most about 45%, at most about 40%, at most about 35%, at most about 30%, at most about 25%, or at most about 20% the surface area of the at least one side/surface of the unidirectional fiber layer. In some embodiments, a discontinuous coating layer covers about 5-75%, about 10-75%, about 15-75%, about 20-75%, about 10-50%, about 20-40%, or about 27-35% the surface area of the at least one side/surface of the unidirectional fiber layer. For example, 5-75% of the surface area of a side/surface of the unidirectional fiber layer can be covered by the discontinuous coating layer (i.e., the plurality of discontinuous coating regions) (the “islands”) and the rest of the surface is uncovered unidirectional fiber layer. In some embodiments, the surface coverage of the discontinuous coating layer can be quantified by microscopy (e.g., scanning electron microscopy).

In some embodiments, the discontinuous coating layer can add a certain roughness or “gritty” texture/surface to the UD tape. The roughness of the UD tape can be measured by calculating the coefficient of variation of the thickness of the UD tape. In some embodiments, a coefficient of variation (CoV) of the thickness of a UD tape can be at least about 2%, at least about 5%, at least about 6%, at least about 7%, at least about 8%, at least about 9%, at least about 10%, at least about 12%, at least about 15%, at least about 20%, or at least about 25%. In some embodiments, a CoV of the thickness of UD tape can be at most about 50%, at most about 40%, at most about 35%, at most about 30%, at most about 25%, at most about 20%, at most about 15%, at most about 12%, or at most about 10%.

In some embodiments, an average height or thickness of the plurality of discontinuous coating regions is about 5-150 microns. The average height or thickness of the plurality of discontinuous coating regions can be calculated by measuring the height of 10 randomly chosen discontinuous coating regions using cross section microscopy and averaging them.

During UD tape production, voids may form between the base unidirectional fiber layer and the discontinuous coating layer(s), within the unidirectional fiber layer, and/or within the discontinuous coating layer(s). However, by partially or discontinuously coating the surface(s) of the unidirectional layer voids may be decreased as compared to a continuous coating on the surface(s) of a unidirectional layer, but can still preserve/maintain surface roughness. In some embodiments, the max void content of the unidirectional tape can be at most about 10%, at most about 8%, at most about 6% at most about 5%, at most about 2%, at most about 1%, or at most about 0.9%. In some embodiments, the max void content of the unidirectional tape can be at least about 0.01%, at least about 0.1%, at least about 0.25%, at least about 0.5%, at least about 0.6%, at least about 0.7%, at least about 0.8%, at least about 0.9%, or at least about 1%. In some embodiments, the max void content of the unidirectional tape can be about 0.01-6%.

As stated above, the discontinuous coating layer(s) can fulfill several functions including fulfilling several functions simultaneously. In some embodiments, the discontinuous coating layer(s) can reduce ply-mold slip or friction and/or ply-ply slip or friction. For example, by discontinuously coating the surface of unidirectional fiber layer with additional polymer, friction between adjacent plies (i.e., ply-ply friction) can be reduced and/or optimized for lateral movement between adjacent plies during the melt phase of laminate consolidation. In other words, the polymer in the discontinuous coating layer can act as a slip plane for lateral movement between plies. The decreased friction between plies and/or between tooling and composite stack can improve formability in various processes (such as stamp forming, thermoforming, etc.) especially in areas of tight bending and/or consolidation of complex shapes. The improved formability can thus allow for faster forming and forming more complex shapes because the plies may be less likely to buckle and/or undulate. In addition, reducing/optimizing ply-ply friction can reduce wrinkles and other defects in the consolidated part. In some embodiments, the ply-ply friction of the unidirectional tapes disclosed herein can be reduced by at least 10%, at least 20%, at least 30%, at least 40%, at least 50%, at least 60%, or at least 70% compared to using standard UD tape without any coating layers. In some embodiments, the peak stress of the unidirectional tapes disclosed herein can be reduced by at least 10%, at least 20%, at least 30%, at least 40%, at least 50%, at least 60%, or at least 70% compared to using standard UD tape without any coating layers.

In some embodiments, the unidirectional tapes disclosed herein have a ply-ply slip which leads to a wrinkle free laminate surface in test parts. The test parts can be made by stampforming a discriminator part with sufficient bend radii to be able to judge differences in ply-ply slip between different thermoplastic UD tapes. Sufficient ply-ply slip can lead to formation of parts with no tactile (out-of-plane) wrinkles at the surface of the part. Insufficient ply-ply slip can lead to formation of parts with tactile wrinkles at the surface of the part.

In some embodiments, the discontinuous coating layer(s) can increase and/or preserve degassing efficiency by preserving inter-ply channels. By discontinuously or partially coating the surface(s) of the unidirectional fiber layer (rather than adding a continuous coating layer), voids or channels can be preserved between a first ply and a mold and/or between subsequent plies in a stack. This can help degas efficiency during various lamination steps such as out-of-autoclave (OOA) and/or vacuum bag only (VBO) while the ply stack is still below the melt temperatures of the polymer(s) in the coating. Degassing efficacy can produce laminates with low void content and/or with increased productivity. The discontinuous coating layer can allow inter-ply channels to be preserved between the first ply and the mold and/or between subsequent plies for degassing (in OOA or VBO consolidation, for example). These voids/channels can be in the form of continuous channels through which gas (e.g., air, moisture, and/or any residual volatiles) can be evacuated during the degassing/debulking steps (of the OOA or VBO process), while the ply stack is still below the melt temperatures of the polymers in the UD tapes. In a subsequent step of consolidation, for example when the fully degassed ply stack is heated above the melt temperatures of the polymer(s), and the stack consolidated (and cooled) under pressure, the voids can be closed without gas (e.g., air, moisture, and/or any volatiles) being trapped in the consolidated UD tapes.

In some embodiments, the discontinuous coating layer(s) can increase and/or preserve inter-ply electrical conductivity and/or thermal conductivity (e.g., Z-conductivities). The discontinuous coating layer(s) disclosed herein can avoid formation of a continuous layer of insulating polymer from forming on a surface of the base unidirectional fiber layer and thus separating adjacent plies in the ensuing laminate which would cause a reduction in inter-ply electrical and/or thermal conductivity. Improving and/or preserving inter-ply conductivity can help processing speed in various lamination processes such as inductive heating and induction welding. However, even where inductive heating or inductive welding is not employed, this feature can enhance processability by increasing thermal conductivity. In addition, improving and/or preserving inter-ply conductivity can also help protect an ensuing laminate from damage where there is a risk of lightning strike.

As stated above, adding additives to the discontinuous coating layer can impart increased inter-ply electrical (Z-)conductivity in an ensuing laminate. For example, formulating (e.g., compounding) the polymer particles added to the unidirectional fiber layer surface with a sufficient amount/concentration of additives (e.g., carbon particles) to exceed the percolation threshold for electrical conductivity within the coating layer can enhance the electrically conductive pathways between adjacent plies.

In some embodiments, the discontinuous coating layer(s) characterized by the specific area coverage and/or surface roughness disclosed herein can lower ply-ply friction, while maintaining sufficient electrical and/or thermal conductivity between adjacent plies. If a continuous coating layer is applied, ply-ply friction may be reduced but at the cost of forming an electrically and thermally insulating layer, which could be detrimental to lamination processes such as inductive heating and induction welding. On the other hand, if no coating is applied, tack weld strength may be too low and ply-ply friction may be too high, and this could be detrimental to part formability and part quality by causing surface wrinkles in the laminate.

In some embodiments, the discontinuous coating layer(s) of the UD tapes disclosed herein can increase the tackiness of the first ply against the mold and/or against subsequent plies. During layup, when a ply stack is close to its melt temperature, the polymer(s) in the discontinuous coating layer locally can increase the tackiness of the first play against the mold and/or against subsequent plies, compared to a unidirectional fiber base with no coating. This can be beneficial for accurate ply registration in AFP and/or ATP processes. In some embodiments, the unidirectional tape disclosed herein can have a tackiness as measured by average or max weld strength (lap shear strength measured after thermal welding) of at least about 100 lb/in, at least about 250 lb/in, at least about 500 lb/in, at least about 750 lb/in, at least about 800 lb/in, at least about 850 lb/in, at least about 900 lb/in, or at least about 1000 lb/in. In some embodiments, the unidirectional tape herein can have a tackiness as measured by average or max weld strength (lap shear strength measured after thermal welding) of at most about 5000 lb/in, at most about 2500 lb/in, or at most about 1000 lb/in. In some embodiments, the tackiness can be measured by measuring the strength of the weld formed after joining two 1″×6″ plies of the unidirectional tape tacked together by means of conventional soldering iron, with 1″ overlap. The welded plies were pulled in a universal testing machine, in tensile mode, with the tensile force perpendicular to the weld. In some embodiments, the tackiness (for ply-ply & ply-old registration) of the unidirectional tapes disclosed herein can increase by at least 10%, at least 20%, at least 30%, at least 40%, at least 50%, at least 60%, at least 70%, or at least 75% compared to using standard UD tape without any coating layers.

In some embodiments, the increased surface roughness from the discontinuous coating layer(s) of the UD tapes can increase the processability of the UD tape giving the part fabricator flexibility in terms of choosing layup and consolidation process. This can be especially true in ultrasonic tape placement and ultrasonic tape laying and laser AFP.

### EXAMPLES

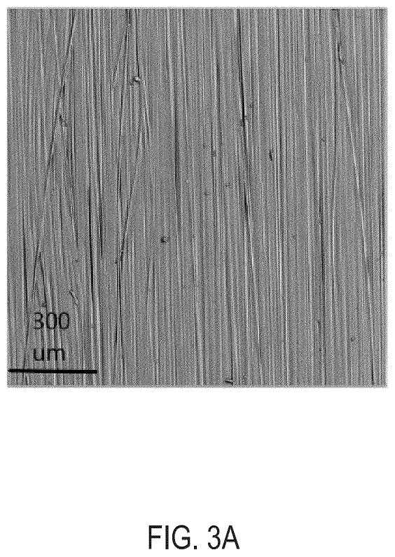

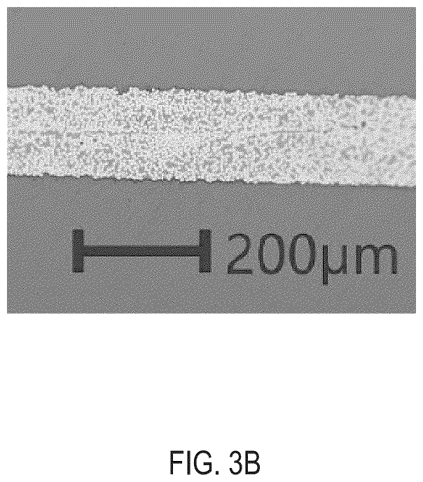

Eight UD tapes and a base tape were created and their top and cross-sectional views were analyzed. The base tape was created with a unidirectional fiber bed of carbon fiber tows and subsequently impregnated with PAEK polymer. The base tape did not include an additional coating. FIGS. 3A-B illustrate a top view at 200× magnification and a cross-sectional view at 500× magnification representative of this UD tape (i.e., base tape) without a coating.

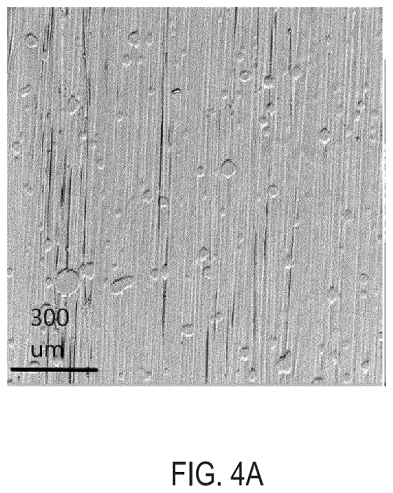

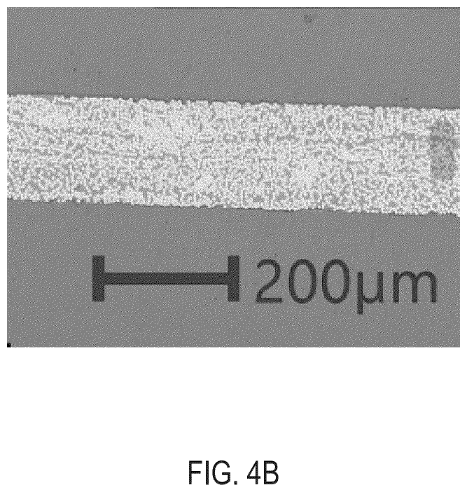

Light coated UD tapes were created with a unidirectional fiber bed of carbon fiber tows and subsequently impregnated with PAEK polymer. A “light” discontinuous coating layer of PAEK polymer was then applied to both sides of the unidirectional fiber layer. FIGS. 4A-B illustrate a top view at 200× magnification and a cross-sectional view at 500× magnification representative of this light coated UD tape. The surface coverage of the unidirectional fiber layer by this discontinuous coating layer varied in the range of 11% to 48% with a Coefficient of Variation in range of 5-7% depending on compaction pressure as shown in the Tables below.

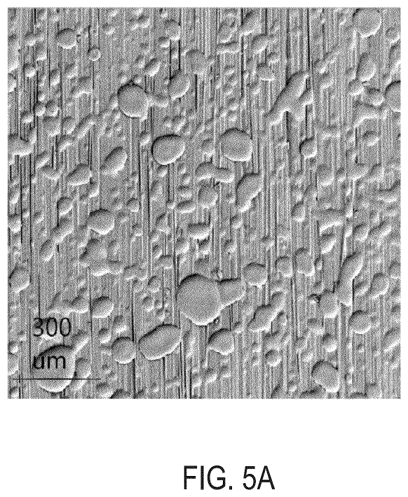

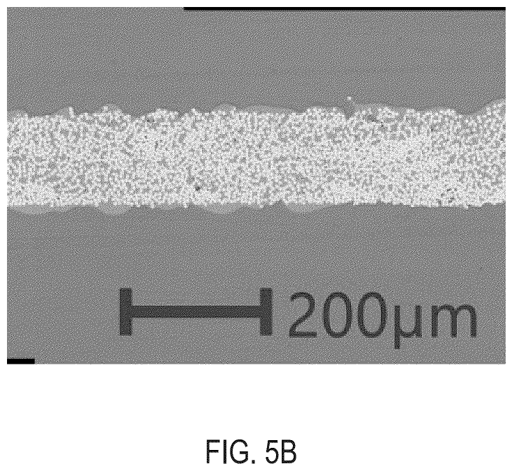

Medium coated UD tapes were created with a unidirectional fiber bed of carbon fiber tows and subsequently impregnated with PAEK polymer. A “medium” discontinuous coating layer of PAEK polymer was then applied to both sides of the unidirectional fiber layer. The surface coverage of the unidirectional fiber layer by this discontinuous coating layer varied in the range of 6% to 79% with a CoV in the range of 8-12% depending on compaction pressure as shown in the Tables below. FIGS. 5A-B illustrate a top view at 200× magnification and a cross-sectional view at 500× magnification of this medium coated UD tape.

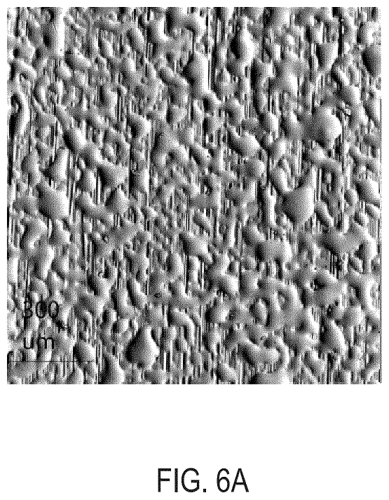

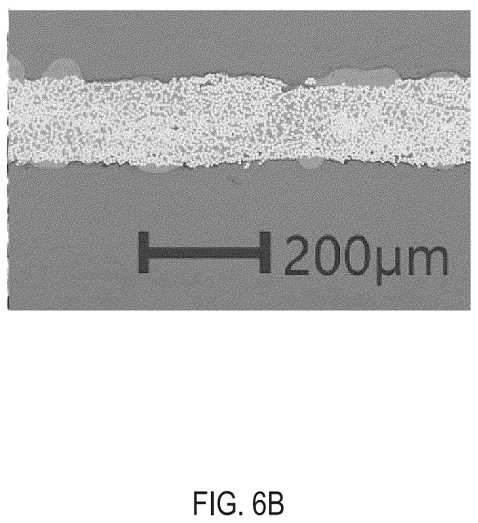

Heavy coated UD tapes were created with a unidirectional fiber bed of carbon fiber tows and subsequently impregnated with PAEK polymer. A “heavy” discontinuous coating layer of PAEK polymer was then applied to both sides of the unidirectional fiber layer. The surface coverage of the unidirectional fiber layer by this discontinuous coating layer varied in the range of 46% to 83% with a CoV of 9% depending on compaction pressure as shown in the Tables below. FIGS. 6A-B illustrate a top view at 200× magnification and a cross-sectional view at 500× magnification of this heavy coated UD tape.

Applicant prepared the following examples compared to base line UD tape with no coating. The specific make-up and properties of the examples and comparative example are shown in the following Tables 1-2:

TABLE 1

| | Percentage of surface | | | Tape | |
|---|---|---|---|---|---|
| | area covered by | | | compaction | |
| | discontinuous coating | | Roughness | pressure | |
| | Method | | | | |
| | Microscopy & | | Microscopy & | | |
| | Statistical | | Statistical | Compaction | |
| | image analysis | | image analysis | roller | |
| | Unit | | | | |
| | | | CoV of | | |
| | % | | coating | | |
| | Average | Range | thickness | N/mm | Coating |
| Base | N/A | | 7% | N/A | N/A |
| Tape | | | | | |
| Exam- | 24% | 6-51% | 12% | 2-5 | Medium |
| ple 1 | | | | | coating |
| Exam- | 32% | 11-48% | 5% | 5-10 | Light |
| ple 2 | | | | | coating |
| Exam- | 37% | 29-48% | 7% | 0.1-2 | Light |
| ple 3 | | | | | coating |
| Exam- | 61% | 36-74% | 8% | 2-5 | Medium |
| ple 4 | | | | | coating |
| Exam- | 62% | 43-79% | 10% | 0.1-2 | Medium |
| ple 5 | | | | | coating |
| Exam- | 69% | 49-83% | 9% | 5-10 | Heavy |
| ple 6 | | | | | coating |
| Exam- | 69% | 46-81% | 9% | 0.1-2 | Heavy |
| ple 7 | | | | | coating |
| Exam- | 71% | 60-83% | 9% | 2-5 | Heavy |
| ple 8 | | | | | coating |

TABLE 2

| | | | Maximum | | | | |
|---|---|---|---|---|---|---|---|
| | | | Void | | | | |
| | | | content in | Ply-ply slip peak | | | |
| | Z-conductivity | | laminate | stress | | Tack weld strength | |
| | Method | | | | | | |
| | | | Acid | | | Lap Shear Strength | |
| | Four-point Probe | | Digestion | Ply-Ply Slip Test | | Measured After Thermal | |
| | Method | | Method | Method | | Welding | |
| | Unit | | | | | | |
| | S/m | | % | ksi | | Lbs/in | |
| | Average | Range | Max | Range | Average | Max | Average |
| Base Tape | 0.08 | 0.07-0.1 | 0.9 | 66-89 | 79 | 485 | 467 |
| Example 1 | 0.04 | 0.03-0.05 | 0.7 | 34-36 | 35 | 723 | 680 |
| Example 2 | 0.1 | 0.06-0.13 | 0.9 | 57-77 | 66 | 538 | 494 |
| Example 3 | 0.08 | 0.06-0.09 | 0.7 | 52-62 | 56 | 518 | 486 |
| Example 4 | 0.09 | 0.07-0.1 | 0.7 | 32-43 | 37 | 683 | 645 |
| Example 5 | 0.09 | 0.08-0.1 | 0.8 | 30-41 | 36 | 817 | 817 |
| Example 6 | 0.07 | 0.06-0.07 | 1.0 | 21-34 | 28 | 604 | 552 |
| Example 7 | 0.08 | 0.07-0.08 | 0.9 | 26-34 | 30 | 716 | 586 |
| Example 8 | 0.06 | 0.04-0.08 | 0.6 | 23-29 | 26 | 794 | 748 |

As shown in the above Tables, the tack weld strength can increase with increasing coverage. The ply-ply slip can correlate with coverage. In other words, increasing ply-ply slip can equate to decreasing peak stress with increasing coverage.

### Calculation of Surface Area Coverage of Discontinuous Coating Layer on Unidirectional Fiber Layer

An example of how to calculate surface area coverage of discontinuous coating layer on a unidirectional fiber layer is as follows. For each sample of UD tape, ten 0.5×0.5 inch specimens were cut from UD tape samples at 5 locations across the width of the tape. Five samples each of top and bottom surfaces were imaged by SEM (scanning electron microscopy). Specimens were sputter coated with 5 nm gold to improve image quality. Each was imaged at 200× using a Phenom XL scanning electron microscope, which produced a 1.3 mm×1.3 mm image. Surface resin was manually identified and marked, then the images were posterized to enhance contrast. Pixels counts were used to determine the percent of resin coverage.

### Calculation of Z-Conductivity

To calculate Z-conductivity of the UD tapes, 12 inch by 16 inch by 10-ply quasi-isotropic laminates of each UD tape were consolidated in a press at 365° at 3.5 bar according to standard industry practices. From each panel, smaller 40 mm×40 mm coupons were cut, polished, and coated with conductive silver paste. The four probe method was used to measure the Resistance, and the corresponding z-conductivity was calculated as Conductivity=t/(R×L*W), where t=thickness, R=resistance, L=length, and W=width.

In some embodiments, the unidirectional tape has a z-conductivity of at least about 0.01 S/m, at least about 0.02 S/m, at least about 0.03 S/m, at least about 0.04 S/m, at least about 0.05 S/m, at least about 0.06 S/m, at least about 0.07 S/m, at least about 0.08 S/m, at last about 0.09 S/m, or at least about 0.1 S/m. In some embodiments, the unidirectional tape has a z-conductivity of at most about 1.5 S/m, at most about 1.25 S/m, at most about 1 S/m, at most about 0.09 S/m, at most about 0.08 S/m, at most about 0.07 S/m, at most about 0.06 S/m, or at most about 0.05 S/m.

### Calculation of Roughness, Degassing Efficiency, and Void Percentage of UD Tape

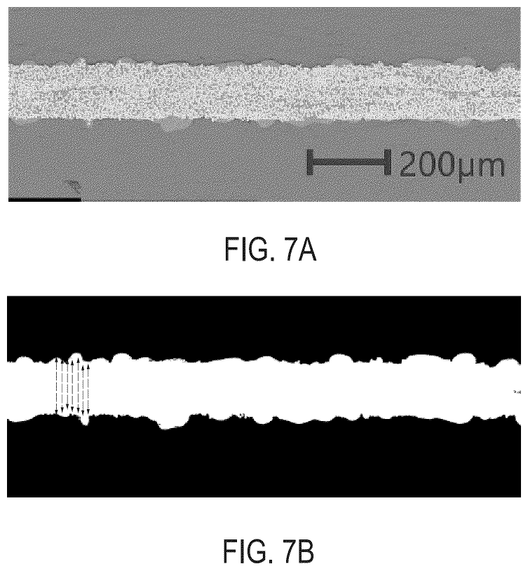

An example of how to calculate roughness (CoV) of UD tapes are as follows. First, prepare samples for determination of surface roughness. UD tape samples were cut and mounted vertically in epoxy resin for potting and polishing. Samples were sanded to 1200 grit, then polished using a 0.3 micron pad. Imaging was done at 200× on a Keyence VHX-6000 optical microscope. Then, take a microscopic image using standard micrograph techniques of the UD tape with fibers facing the polished surface. Take at least a 15 mm wide image for a representative sample size. FIG. 7A illustrates a magnified and smaller segment of the 15 mm wide image. Next, distinguish the UD tape from the potting epoxy using black and white thresholding. The polymers of the UD tape (shown in white) will have a different color than the potting resin (shown in black) as show in FIG. 7B. The thickness of the UD tape is then measured every 1-5 microns to calculate the thickness distribution. From this, the standard deviation, mean, and Coefficient of Variation (CoV) can be calculated. The roughness of the UD tape is the coefficient of variation of the UD tape's thickness.

In some embodiments, the statistical distribution of thickness can follow a bi- or multimodal distribution with the main mode describing the thickness of the base tape, and the other modes shifted by 25% (+/−15%) of the base tape thickness (created by the resin discontinuous coating regions on the surface). In some embodiments, the distribution can generally be wider than that of classical composite tape with a CoV of about 12% (+/−4%). In some embodiments, PDE of the thickness distribution can be obtained by counting every measured thickness and its occurrence (n>10000) measurements (see FIG. 7B).

To quantify degassing efficiency of the UD tapes, the void content of thick laminates made from the UD tapes was determined. 12 inch by 12 inch by 40-ply cross-ply laminates of each UD tape were consolidated by vacuum bagging according to standard industry practices. Void percentages were then determined for each laminate following industry standard ASTM methods for acid digestion and density determination. Degassing efficiency can be measured in terms of void content, because the higher the degas efficiency, the lower the void content there will be in a laminate consolidated from individual plies of the UD tape.

### Calculation of Ply-Ply Slip

A ply-ply friction tester was used to measure the resistance against slippage between adjacent plies. A detailed description of the test machine and general test method is found in Composites: Part A 179 (2024) 108040, which is hereby incorporated by reference in its entirety. For these specific tests, specimens consisted of three 50-mm wide plies cut from samples of UD tape: a single central ply measuring 150-mm long and two outer plies measuring 120-mm long with the fibers oriented in the longitudinal direction. The three plies overlapped over a length of 60 mm, resulting in two ply-ply interfaces. The plies were pressurized between heated platens with a contact area A of 50×50 mm². The temperature was set at 365° C. and a 15 kPa normal pressure was applied. A constant sliding rate of 25 mm/min was applied, forcing the central ply to slide against the outer plies. The required pulling force Fₚᵤₗₗ was logged, together with the displacement d and time t. The shear stress per slip interface was obtained from τ=Fₚᵤₗₗ/2A.

In some embodiments, the ply-ply slip stress of the unidirectional tapes disclosed herein can be at least about 15 ksi, at least about 20 ksi, at least about 25 ksi, at least about 30 ksi, at least about 35 ksi, at least about 40 ksi, at least about 45 ksi, at least about 50 ksi, or at least about 55 ksi. In some embodiments, the ply-ply slip stress of the unidirectional tapes disclosed herein can be at most about 80 ksi, at most about 75 ksi, at most about 70 ksi, at most about 65 ksi, at most about 60 ksi, at most about 55 ksi, at most about 50 ksi, at most about 45 ksi, at most about 40 ksi, at most about 35 ksi, at most about 30 ksi, or at most about 25 ksi.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein. Finally, the entire disclosure of the patents and publications referred in this application are hereby incorporated herein by reference.

1. A unidirectional tape comprising:
a unidirectional fiber layer comprising a plurality of unidirectional fibers and a first polymer; and a
a discontinuous coating layer comprises a plurality of discontinuous coating regions on at least one side of the unidirectional fiber layer, wherein the discontinuous coating layer comprises a second polymer.

2. The unidirectional tape of claim 1, wherein the discontinuous coating layer covers 5-75% of a surface area of the at least one side of the unidirectional fiber layer.

3. The unidirectional tape of claim 1, wherein a thickness of the unidirectional tape has a coefficient of variation (CoV) of 5-50%.

4. The unidirectional tape of claim 1, wherein the first polymer and/or second polymer comprises polyarylether ketone-based polymeric material, polyphenylene sulfide (PPS), polyethersulfone (PES or PESU), polyethylenimine (PEI), or combinations thereof.

5. The unidirectional tape of claim 1, wherein the first and second polymers are the same.

6. The unidirectional tape of claim 1, wherein the plurality of unidirectional fibers comprises carbon fibers, glass fibers, or combinations thereof.

7. The unidirectional tape of claim 1, wherein the discontinuous coating layer comprises conductive additives.

8. The unidirectional tape of claim 7, wherein the conductive additives comprise carbon particles.

9. The unidirectional tape of claim 8, wherein the carbon particles have a mean diameter of a volume distribution of 10-50 microns.

10. The unidirectional tape of claim 8, wherein the discontinuous coating layer comprises 2-10 wt. % carbon particles.

11. The unidirectional tape of claim 1, wherein the unidirectional fiber layer comprises conductive additives.

12. The unidirectional tape of claim 11, wherein the conductive additives comprise carbon black, graphene, carbon nanotubes (CNT), milled carbon fiber, milled carbon fiber prepreg, or combinations thereof.

13. The unidirectional tape of claim 11, wherein the conductive additives have a mean diameter of a volume distribution of 20 nanometers to 1 micron.

14. The unidirectional tape of claim 11, wherein the unidirectional fiber layer comprises 0.1-10 wt. % conductive additives.

15. A method of producing a unidirectional tape comprising:
preparing a unidirectional fiber layer comprising a plurality of unidirectional fibers and a first polymer;
discontinuously coating at least one side of the unidirectional fiber layer with a plurality of particles comprising a second polymer;
heating the plurality of particles such that the plurality of particles coalesce into a plurality of discontinuous regions on the at least one side of the unidirectional fiber layer; and
pressing the at least one side of the coated unidirectional fiber layer to form the unidirectional tape.

16. The method of claim 15, wherein the plurality of particles have an average particle diameter of 5-500 microns.
